(19) United States
(12) Patent Application Publication
(10) Pub. No.: US 2025/0265639 A1
(43) Pub. Date: Aug. 21, 2025

(54) SERVER FOR CONDUCTING REAL ESTATE TRANSACTIONS AND RELATED METHOD

(71) Applicant: KELSEY DUNCAN, TAMPA, FL (US)

(72) Inventor: KELSEY DUNCAN, TAMPA, FL (US)

(21) Appl. No.: 19/057,311

(22) Filed: Feb. 19, 2025

Related U.S. Application Data
(60) Provisional application No. 63/555,438, filed on Feb. 20, 2024.

(51) Int. Cl. G06Q 30/0601; G06Q 10/0631; G06Q 30/02; G06Q 50/16

(52) U.S. Cl. CPC G06Q 30/0643; G06Q 10/06311; G06Q 30/0278; G06Q 50/16

(57) ABSTRACT

A server is for a sale transaction for a given real estate property. The server includes a processor configured to communicate with a first communications device associated with a seller user, and a second communications device associated with a buyer user. The processor is configured to provide a seller GUI for the first communications device, receive via the seller GUI characteristic values for the given real estate property, and provide via the seller GUI, vendor options for the given real estate property. The processor is configured to schedule via the seller GUI, a vendor appointment for the given real estate property, generate a listing for the given real estate property based upon the characteristic values and an external database, provide a buyer GUI for the second communications device, and receive via the buyer GUI, an offer for the given real estate property. The processor also is configured to coordinate the sale transaction of the given real estate property via the seller GUI and the buyer GUI.

### RELATED APPLICATION

This application is based upon prior filed copending Application No. 63/555, 438 filed Feb. 20, 2024, the entire subject matter of which is incorporated herein by reference in its entirety.

### TECHNICAL FIELD

The present disclosure relates to the field of real estate, and, more particularly, to conducting purchase transactions for real estate properties and related methods.

### BACKGROUND

In the pre-Internet age, when seeking information regarding real estate, the user was quite often frustrated with incomplete listings and outdated information. With the advent of the Internet Age and the real estate boom, several approaches to this issue were developed. Indeed, some online products have become near ubiquitous in the real estate business. For example, Trulia and Zillow (as available from Zillow, Inc. of Seattle, Washington) are both home and neighborhood websites that are routinely used in the real estate field.

### SUMMARY

Generally, a server is for a sale transaction for a given real estate property. The server comprises a processor and memory coupled thereto and configured to communicate with a first communications device associated with a seller user, and a second communications device associated with a buyer user. The processor is configured to provide a seller graphical user interface (GUI) for the first communications device, receive via the seller GUI a plurality of characteristic values for the given real estate property, and provide via the seller GUI a plurality of vendor options for the given real estate property. The processor is configured to schedule via the seller GUI at least one vendor appointment for the given real estate property, generate a listing for the given real estate property based upon the plurality of characteristic values and at least one external database, provide a buyer GUI for the second communications device, and receive via the buyer GUI at least one offer for the given real estate property. The processor also is configured to coordinate the sale transaction of the given real estate property via the seller GUI and the buyer GUI.

In particular, the external database may comprise a local property appraiser database. The plurality of characteristic values may comprise an area value for the given real estate property, a sale price value for the given real estate property, a number of bedrooms for the given real estate property, and a number of bathrooms for the given real estate property, for example.

Also, the processor may be configured to transmit the listing to an external listing database. The processor may be configured to receive via the buyer GUI at least one credential for the buyer user. The processor may be configured to provide the buyer GUI to include a scheduling interface for permitting scheduling of showings for give real estate property.

Another aspect is directed to a method for performing a sale transaction for a given real estate property with a server. The method comprises establishing communications with a first communications device associated with a seller user, and a second communications device associated with a buyer user, and providing a seller GUI for the first communications device. The method includes receiving via the seller GUI, a plurality of characteristic values for the given real estate property, providing via the seller GUI, a plurality of vendor options for the given real estate property, and scheduling via the seller GUI, at least one vendor appointment for the given real estate property. The method also includes generating a listing for the given real estate property based upon the plurality of characteristic values and at least one external database, providing a buyer GUI for the second communications device, receiving via the buyer GUI, at least one offer for the given real estate property, and coordinating the sale transaction of the given real estate property via the seller GUI and the buyer GUI.

### BRIEF DESCRIPTION OF THE DRAWINGS

FIG. 1 is a schematic diagram of a communication system, according to the present disclosure.

FIG. 2 is a flowchart of a method for operating the server of FIG. 1.

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout.

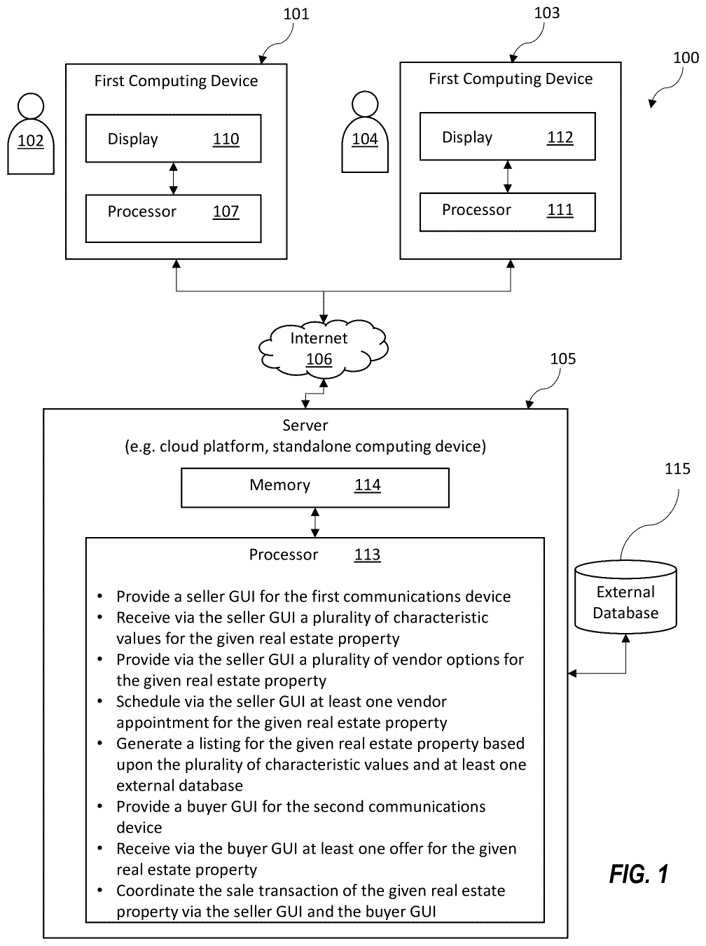

Referring initially to FIG. 1, a communication system 100 for a sale transaction for a given real estate property is now described. The communication system 100 illustratively comprises a first communications device 101 associated with a seller user 102, a second communications device 103 associated with a buyer user 104, and a server 105 in communication with the first and second communications devices over a private/public network, for example, the illustrated Internet 106. Further, the server 105 may comprise a standalone computing device, or assigned resources within a cloud computing platform (e.g., Amazon Web Services, Google Cloud Computing Platform, or Microsoft Azure).

The first communications device 101 illustratively includes a processor 107, and a display 110 cooperating therewith. The second communications device 103 illustratively includes a processor 111, and a display 112 cooperating therewith. Each of the first communications device 101 and the second communications device 103 may comprise a mobile device, such as a cellular device or a tablet computing device, or a personal computing device, for example. Indeed, any device with a display may be used. For illustrative clarity, only the first communications device 101 and the second communications device 103 are depicted, but it should be appreciated that the communication system 100 may include a large number of devices and associated buyer/seller users.

The server 105 comprises a processor 113 and memory 114 coupled thereto and configured to communicate with the first communications device 101, and the second communications device 103. The processor 113 is configured to cooperate with the first communications device 101 to provide a seller GUI (e.g., webpage rendered GUI) for the first communications device. Within this seller GUI, the server 105 may provide the seller user 102 with informational data regarding the sale process. In some embodiments, the seller GUI may include a video interface for providing this information with an informational video.

Once the seller user 102 starts the sale process for the given real estate property (e.g., clicking “sell my home” button with the seller GUI), the processor 113 is configured to receive via the seller GUI, a plurality of characteristic values for the given real estate property. The plurality of characteristic values may comprise an area value for the given real estate property, a sale price value for the given real estate property, a number of bedrooms for the given real estate property, a number of bathrooms for the given real estate property, and a zip code for the given real estate property, for example.

The processor 113 is configured to provide via the seller GUI, a plurality of vendor options for the given real estate property. For example, the plurality of vendor options may comprise home stagers, home photographers, home painters, title company, home inspector, attorneys, etc. In short, the plurality of vendor options includes any third party support potentially needed by the seller user 102 for the transaction.

If the seller user 102 selects one of the vendor options, the processor 113 is configured to launch a calendaring interface to coordinate schedules of the seller user and the selected vendor option. The processor 113 is configured to schedule via the seller GUI, one or more vendor appointments for the given real estate property. Further, the seller GUI includes a community review interface for reviewing past performance of the plurality of vendor options.

The processor 113 is configured to generate a listing for the given real estate property based upon the plurality of characteristic values and an external database 115. The listing for the given real estate property may be transmitted to industry databases and websites, such as Zillow, Trulia, MLS, etc.

In particular, the external database may comprise a local property appraiser database. Here, the processor 113 may aggregate data from a verified database to correct the inputted values for the plurality of characteristic values. For example, if the area value for the given real estate property is inconsistent with the value in the local property appraiser database, the seller user 102 may be prompted to approve a correction.

The processor 113 is configured to provide a buyer GUI for the second communications device 103. In some embodiments, the buyer GUI includes access to a plurality of listings for different real estate properties. In other embodiments, the buyer GUI is reached once clicking on the respective listing in a typical database, such as Zillow. Also, the buyer GUI includes a document upload interface for permitting the buyer user 104 to upload credentials for the transaction, for example, a preapproval letter for financing the transaction, identification credentials. Also, the buyer GUI may include a scheduling interface for permitting scheduling of showings of the given real estate property.

The processor 113 is configured to receive via the buyer GUI an offer for the given real estate property. This offer is then presented to the seller user 102 within the seller GUI, along with other offers from other users. The processor 113 is configured to coordinate direct communication between the seller user 102 and the buyer user 104, in particular, counter offers and proposals, questions about the real estate property.

The processor 113 is configured to coordinate the sale transaction of the given real estate property via the seller GUI and the buyer GUI after the seller user 102 and the buyer user 104 agree to terms for the transaction. In other words, the processor 113 is configured to coordinate the due diligence period, and closing of the transaction for the given real estate property. In some embodiments, the processor 113 is configured to connect the calendars of the seller user 102 and the buyer user 104 along with the title company. For example, the seller GUI and the buyer GUI each includes a synchronized timer till scheduled closing. Also, in some embodiments, the processor 113 is configured to receive payment from the buyer user 104 for the earnest deposit, and place those funds into escrow until closing.

The buyer GUI and the seller GUI may be provided within a web browser interface for rendering on the first communications device 101 and the second communications device 103. In other embodiments, each of the first communications device 101 and the second communications device 103 may execute local native software applications in communication with the server 105 for providing the buyer GUI and seller GUI.

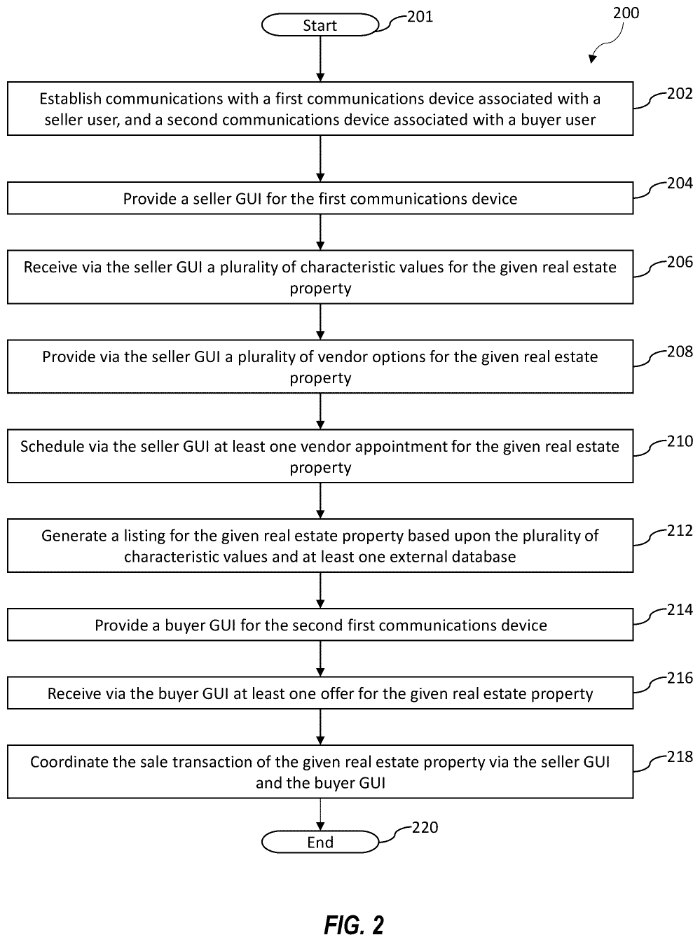

Referring now additionally to FIG. 2, a method performing a sale transaction for a given real estate property with a server 105 is now described with reference to a flowchart 200, which begins at Block 201. The method comprises establishing communications with a first communications device 101 associated with a seller user 102, and a second communications device 103 associated with a buyer user 104 (Block 202), and providing a seller GUI for the first communications device (Block 204). The method includes receiving via the seller GUI a plurality of characteristic values for the given real estate property (Block 206), providing via the seller GUI a plurality of vendor options for the given real estate property (Block 208), and scheduling via the seller GUI at least one vendor appointment for the given real estate property (Block 210). The method also includes generating a listing for the given real estate property based upon the plurality of characteristic values and an external database 115 (Block 212), providing a buyer GUI for the second communications device 103 (Block 214), receiving via the buyer GUI an offer for the given real estate property (Block 216), and coordinating the sale transaction of the given real estate property via the seller GUI and the buyer GUI (Block 218). The method ends at Block 220.

In the following, the typical steps for a transaction for the given real estate property are described. It should be appreciated that this discussion is exemplary, and some of the features may be omitted in some embodiments.

### Seller User Steps

1. Click “sell my home” on the seller GUI provided by the server 105.
2. Watch short 30-60 second introduction video of what you can expect the process to be like.
3. Be guided to the provider's page to choose stagers and photographers. The software application provided via the server 105 will prompt them to choose a listing date, square footage and bed/bath count, as well as zip code. This form will be sent out to all available providers in the categories, and those who can and desire to bid the project will respond via pre-made form with availability and pricing.
4. Sellers can review online reviews (e.g., Google Reviews) of each company and choose who they would like to go with. Once a choice has been made, the provider will send an in-application calendar request to the seller. This calendar can export to third party calendars, but it will not import any outside calendars to keep the application clear of outside noise. The same process is repeated for every single provider booking from both seller and buyer point of view. When a contract is accepted by a seller, the buyer and seller calendars join together for future deadlines and provider appointments (e.g., appraiser, inspector, etc.).
5. Photos are provided to the seller from the photographer, and the seller is now prompted to list the home. There will be a comparative market analysis (CMA) option on the site/mobile platform where sellers and buyers can pay to have a CMA report run that will not disrupt the process but will give them an idea how much to list their home for. Perhaps a prompt can pop up before the listing of the home or in the “sales price” text box that will take them to the CMA option. The CMA option may be provided internally or outsourced to third parties.
6. Data from tax records are imported when the address of the home is inputted via syndication site and editable (i.e., square footage, bed/bath count, etc.). Seller's disclosure form (standard for each state) and any other standard form will pop up to be filled out prior to listing.
7. Home description example is pre-filled in the text box for seller's to change as needed.
8. Title company is chosen by the seller in some states. In Florida's case, if the seller wants to choose, the title company will be looped in once an offer is accepted.
9. Home is then listed on online marketplaces (e.g., Zillow, Trulia) and pushed to several other syndicated home sites like by clicking “list my home” (e.g., MLS).
10. Home is listed.

### Offer Received

11. All offers are received in-application, and sellers have the ability to consult with a flat fee attorney to review specific offers or to make a counter.
12. Counteroffer/offer is accepted and buyer and seller 12. are now under contract.

### Offer Accepted-Buyer and Seller Join

13. Buyer and seller are now under contract. Due Diligence (DD) period begins and countdown in-application begins. The seller's calendar is now linked with the buyer's and as providers are chosen by buyers, the appointment requests go to both buyer and seller in-application.
14. Relevant appointments take place.
15. If a repair is needed, the buyer will submit in-application to the seller. Seller will review and any repairs made will be recorded in-application to be sent to the title company prior to closing (e.g., photos and receipts).
16. DD period ends, and title company handles the transaction from this point forward.

### Buyer Journey from Homepage to Closing

1. View listings of nearby homes or type address into the search bar to find the home you are looking to buy.
2. Upload a copy of your pre-approval letter or choose to connect with one of our lenders in our providers section.
3. Once you have uploaded your pre-approval letter, you are now able to schedule self-showings of homes in your area after signing off on our waiver and providing a copy of your driver's license transaction.

### Offer Made

4. Once you have found a home to make an offer on, watch our short introduction video to making offers and choose the appropriate form for your offer to fill out. Pop-up bubbles will show up with small icons to describe what goes in each box.
5. Before submitting the offer, you will be prompted to confirm or deny the desire to have a flat fee attorney review your offer same-day return.
6. The email of the seller (or seller's agent) will be used to send offers and will contain a download link with a short introduction video to the company. This should make the seller feel like they need access to the platform for a smooth process.
7. If a counteroffer is received, the buyer can hire that same flat-fee attorney to review and make any changes.

### Offer Accepted-Buyer and Seller Join

8. The offer is accepted, the buyer and seller are now under contract and their calendars are synchronized.
9. Title company is typically chosen by sellers.
10. If the seller chooses the title company, the title company will automatically be looped in with the buyers and initiate earnest money wire instruction information as well as DD begin and end date.
11. The earnest money deposit (EMD) once received will notify both buyer and seller and the countdown in-application will begin. The application will remind the buyer that if they do not cancel the contract prior to the end of DD, they will not be given a refund of the EMD. Reminders will pop up and a waiver will be signed stating they are aware.
12. Buyers are now prompted to choose a home inspector and appraiser (if required by financing) and schedule the necessary appointments. The seller will receive a copy of requested dates by the buyer's providers via the application and the provider will confirm with both parties.
13. All copies of inspections will be delivered in app via PDF and via email (document storage is in-application).
14. If anything is found during DD that needs to be addressed, buyers will have access to a form that asks them to request changes prior to closing.
15. Any repairs made by sellers that were requested will be uploaded to the application in digital document form to be printed and can be brought to closing (e.g., receipts, photos).
16. DD period ends, buyer and seller is notified that the earnest money has “gone hard” or non-refundable and that time to close is X days.
17. Title company handles the transaction from this point forward.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

1. A server for a sale transaction for a given real estate property, the server comprising:
a processor and memory coupled thereto and configured to communicate with a first communications device associated with a seller user, and a second communications device associated with a buyer user, the processor configured to
provide a seller graphical user interface (GUI) for the first communications device,
receive via the seller GUI a plurality of characteristic values for the given real estate property,
provide via the seller GUI a plurality of vendor options for the given real estate property,
schedule via the seller GUI at least one vendor appointment for the given real estate property,
generate a listing for the given real estate property based upon the plurality of characteristic values and at least one external database,
provide a buyer GUI for the second communications device,
receive via the buyer GUI at least one offer for the given real estate property, and
coordinate the sale transaction of the given real estate property via the seller GUI and the buyer GUI.

2. The server of claim 1 wherein the external database comprises a local property appraiser database.

3. The server of claim 1 wherein the plurality of characteristic values comprises an area value for the given real estate property, a sale price value for the given real estate property, a number of bedrooms for the given real estate property, and a number of bathrooms for the given real estate property.

4. The server of claim 1 wherein the processor is configured to transmit the listing to an external listing database.

5. The server of claim 1 wherein the processor is configured to receive via the buyer GUI at least one credential for the buyer user.

6. The server of claim 1 wherein the processor is configured to provide the buyer GUI to include a scheduling interface for permitting scheduling of showings for give real estate property.

7. A method for performing a sale transaction for a given real estate property with a server, the method comprising:
establishing communications with a first communications device associated with a seller user, and a second communications device associated with a buyer user;
providing a seller graphical user interface (GUI) for the first communications device;
receiving via the seller GUI a plurality of characteristic values for the given real estate property;
providing via the seller GUI a plurality of vendor options for the given real estate property;
scheduling via the seller GUI at least one vendor appointment for the given real estate property;
generating a listing for the given real estate property based upon the plurality of characteristic values and at least one external database;
providing a buyer GUI for the second communications device;
receiving via the buyer GUI at least one offer for the given real estate property; and
coordinating the sale transaction of the given real estate property via the seller GUI and the buyer GUI.

8. The method of claim 7 wherein the external database comprises a local property appraiser database.

9. The method of claim 7 wherein the plurality of characteristic values comprises an area value for the given real estate property, a sale price value for the given real estate property, a number of bedrooms for the given real estate property, and a number of bathrooms for the given real estate property.

10. The method of claim 7 further comprising transmitting the listing to an external listing database.

11. The method of claim 7 further comprising receiving via the buyer GUI at least one credential for the buyer user.

12. The method of claim 7 further comprising providing the buyer GUI to include a scheduling interface for permitting scheduling of showings for give real estate property.
